(19) United States
(12) Patent Application Publication
(10) Pub. No.: US 2021/0276633 A1
(43) Pub. Date: Sep. 9, 2021

(54) AERODYNAMIC BLADE ACTUATED BY AN ENERGY STORAGE DEVICE

(71) Applicant: COMPAGNIE PLASTIC OMNIUM

(72) Inventors: Gérald ANDRE, Saint Denis en Bugey (FR); Bertrand MAZUE, LYON (FR); Julien JACOMY, MORESTEL (FR); Jérôme UTTER, BETTANT (FR)

(21) Appl. No.: 16/496,036

(22) PCT Filed: Mar. 16, 2018
(86) PCT No.: PCT/FR2018/050650

§ 371 Date: Sep. 20, 2019

(30) Foreign Application Priority Data
Mar. 20, 2017 (FR) 1752259

(51) Int. Cl. B62D 35/00; B60K 11/08

(52) U.S. Cl. CPC B62D 35/00; B60K 11/085

(57) ABSTRACT

An aerodynamic blade for a motor vehicle includes a shutter mounted on a support shaft having an axis and connected to a chassis of a vehicle by at least one support, and driven in rotation around said axis between an open position and a closed position by a motor assembly. The motor assembly includes one or more elements configured to accumulate mechanical energy and having an adjustable stored energy level to meet a demand for a sufficient torque to change a position of the shutter in a time of less than one second.

### TECHNICAL FIELD

The invention concerns the domain of automobile vehicles, and, more particularly, aerodynamic devices arranged at specific places on a vehicle in order to reduce the aerodynamic drag created by the vehicle when moving at high speed, or even to open or close an air intake duct.

### BACKGROUND

The beneficial effects are well-known that are obtained using mobile shutters which are arranged in front of air intakes in order to close passages which may introduce volumes of cooling air into the interior of the vehicle, or placed in front of the vehicle in order to reduce the air flow passing under the vehicle, or which are even arranged at the rear of the vehicle in order to channel the turbulent flows caused by speed.

As a general rule, these shutters are driven in translation or rotation around an axis, by electric actuators. These relatively flexible means make it possible to voluntarily open or close the aerodynamic blade as a function of the configuration of the rolling of the vehicle. The shutters then alternate between an open position and a closed position and, in a few very rare cases, between one or two intermediate positions. The assembly formed by the shutters and their motorization group, comprising the actuators, forms an aerodynamic blade.

Despite their benefits, the actuators nonetheless present the problem of being energy consumers, in particular, when the movements to be made require high torques. In addition, in certain configurations, the shutters are mounted such that their axes of rotation are located substantially in the immediate proximity of the surface of the vehicle body with the goal of reducing any obstruction of the aerodynamic blade. This arrangement results in the creation of additional torque caused by the aerodynamic forces in play on the surface of the shutters when the vehicle is moving at high speed, which is added to the torque of opening or closing.

In order to reduce this motor torque and to enable the use of lower-powered motors, the use of geared motor sets can be envisaged, making it possible to multiply actuator forces to the detriment of the speed of change of position. These reduction mechanisms therefore present the problem of slowing the movements of the shutter.

### SUMMARY

The object of the invention is to provide an original solution to the problem described above.

The aerodynamic blade according to the invention is intended to be fitted to a motor vehicle. It comprises a shutter mounted on a shaft support an XX axis, which is connected to a vehicle chassis by at least one support, and which is driven in rotation around said axis between an open position and a closed position by a motor assembly.

This aerodynamic blade is characterized in that said motor assembly comprises mechanical energy accumulation means for which the level of stored energy is adjustable in order to meet the demand for sufficient torque making it possible for the shutter to change position almost instantaneously, including in under 1 second.

Mechanical energy accumulator means a mechanical means for which the potential energy is variable and adaptable, which is capable of delivering this energy in the form of mechanical work, produced by a force and a displacement, in this case, a torque and a rotation, in response to a given order.

By way of example, a retaining of water, a mass arranged at the end of a pendulum, or even a spring, as we will see hereafter, are accumulators of mechanical energy.

Although they may be associated with electrical devices, they are distinguished from electrical energy accumulators, which, with a battery or a condenser as examples, in most cases call upon chemical or electrical devices.

The energy accumulator may, therefore, be recharged using low power means for a given duration, in the period of time preceding the passage of the shutter from the open position to the closed position, or from the closed position to the open position.

The stored energy level is variable and will depend, in accordance with the examples cited above, on the level of the water, the height of the mass or even the tension in the spring. This level of energy may also be adjustable, such that the quantity of work delivered remains limited to only that which is specifically necessary in order to move the shutter from one position to the other.

The torque delivered by the energy accumulator is an opening torque or a closing torque, depending on the initial open or closed position of the shutter.

The device according to the invention may also comprise, alone or in combination, the following characteristics:
The mechanical energy accumulation means are formed by a torsion spring of axis XX′.
The motor assembly comprises a locking assembly equipped with a mobile, interlocking digit in translation between a first and a second position, and configured such that, when the interlocking digit is in the first position, the rotation of the support shaft is blocked when the shutter is in the open or closed position, and when the interlocking digit is in the second position, the support shaft is in free rotation.
The locking assembly comprises a locking disc of axis XX′, mounted on the support shaft, comprising a first and a second housing to receive the interlocking digit in the first position, when the shutter is, respectively, in the open position or in the closed position.
The motor assembly comprises a principal actuator fixed to the chassis of the vehicle driving an engine sprocket of a given diameter, coaxial to the axis of the support shaft, connected to a drive pinion mounted in free rotation on the support shaft.
The diameter of the drive pinion is greater than or equal to the diameter of the engine sprocket.
A first axial extension of the torsion spring is mounted in an insertion arranged on an edge of the shutter and a second axial extension of the torsion spring is mounted in an insertion arranged on a face of the drive pinion, such that the rotating of the engine sprocket in a rotational direction or in another direction, creates the tensioning of the torsion spring when the interlocking digit is in the first position.
When the interlocking digit is in the second position, the shutter is driven in rotation from one position to another by the effect of the torque created by the torsion spring.
The motor assembly comprises shock absorbing means to brake the rotation of the support shaft.
The motor assembly comprises a position sensor making it possible to determine the open or closed position of the shutter.
The aerodynamic blade is associated with a central unit comprising algorithms in the form of coded instruction which, when executed, control:
   the rotating of the principal actuator in a rotational direction or in another direction in order to adjust the tension of the torsion spring,
   the position of the interlocking digit.
The central unit comprises an algorithm making it possible to drive the principal actuator so as to adjust the tension of the torsion spring as a function of the parameters of the vehicle.
The central unit comprises an algorithm making it possible to drive the locking assembly in order to control the passage of the shutter from one position to another as a function of the threshold resulting from said vehicle parameters.
Said vehicle parameters comprise a vehicle speed, and/or a cooling water temperature, and/or a detector of an imminent need such as a shock or the securitization of the vehicle.
The central unit comprises an algorithm authorizing a single change of position of the shutter in a given time interval, preferentially between 5 and 30 seconds.
The central unit comprises an algorithm making it possible to drive the principal actuator so as to adjust successive supports as a function of said vehicle parameters, and when the interlocking digit is in the first position, the tension of the torsion spring is such that, in the case of an order for the changing of the position of the shutter, the addition of the torque delivered by the torsion spring and of the torque created by the aerodynamic forces acting on the shutter remains between two predetermined limits.
The central unit comprises an algorithm making it possible to drive the principal actuator so as to bring the tension of the spring to a value close to zero when the vehicle motor is turned off.

### BRIEF DESCRIPTION OF THE DRAWINGS

The invention will be better understood after a review of the attached figures, which are provided by way of examples and are not limitative, in which:

FIG. 1 is a schematic representation of a front view of an aerodynamic blade according to the invention.

FIG. 2 is a schematic representation of a side view of the locking assembly.

FIGS. 3a, 3b, 3c are schematic representations in front view and side view of the position sensor.

FIG. 4 represents diagrams making it possible to follow the evolution of the pre-tension imposed on the torsion spring as a function of time and of the speed of the vehicle as a function of time.

### DETAILED DESCRIPTION

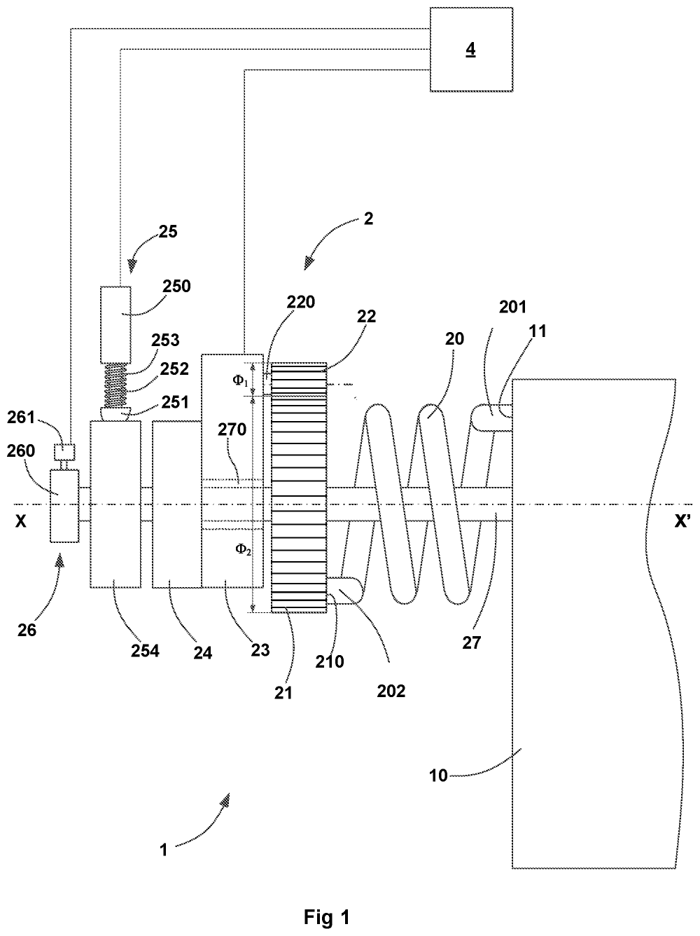

Aerodynamic blade 1, illustrated in FIG. 1, is the assembling of a shutter 10 and of a motor assembly 2.

The shutter 10 is mounted on a support shaft 27 of axis XX′. This support shaft is connected to the chassis of the vehicle (not shown) by a support 270. In the example used to support this specification, the support 270, represented by the dotted lines, is implanted in a casing of a principal actuator 23, itself fixed to the chassis of the vehicle. The support shaft 27 may also be connected to the chassis by two supports located axially on both sides of the shutter 10.

The principal actuator 23 comprises an electric motor (not visible) driving in rotation a motor shaft 220 supporting an engine sprocket 22 of a given Φ₁ diameter. The axis of the engine sprocket 22 and of the motor shaft 220 is parallel to the axis XX′ mounted in free rotation on the support shaft 27.

The engine sprocket is connected to a gear shaft 21 of axis XX′ mounted in free rotation on the support shaft 27. The gear shaft 21 has a diameter Φ₂ preferentially greater than or equal to the diameter Φ₁ of the engine sprocket 22.

A torsion spring 20, coaxial to the support shaft, is interposed between the and the gear shaft 21. This torsion spring 20 comprises a first axial extension 201 making it possible to anchor the first extremity of the torsion spring 20 in an insertion 11 arranged on the edge of the shutter 10, and a second axial extension 202 making it possible to anchor the second extremity of the torsion spring 20 in an insertion arranged in a face of the gear shaft 21.

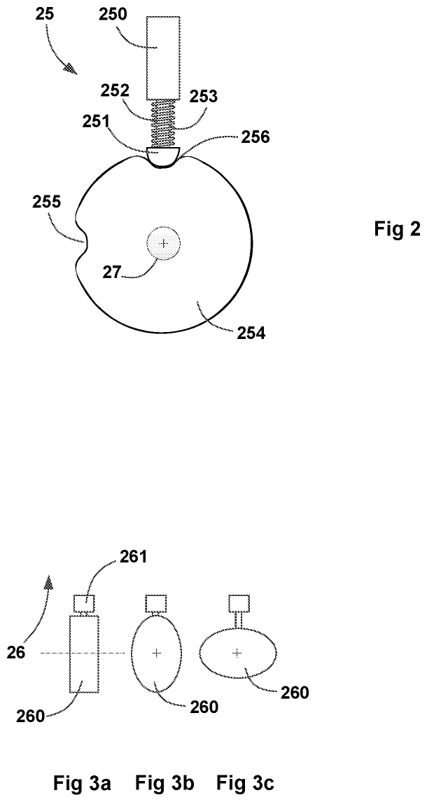

A locking assembly 25 completes the mechanism above, by controlling the rotation or blocking of the support shaft 27. Also visible in FIG. 2, the locking assembly 25 comprises a locking disc 254, connected to the support shaft 27.

The locking disc 254 comprises a first and second housing, respectively 255 and 256, arranged on the periphery of the disc 254. An interlocking digit 251 is driven in translation between a first and a second position by an electromagnet 250 connected to the chassis of the vehicle. In the first position, the interlocking digit 251 penetrated into one of the housings 255, 256, and prevents the rotation of the support shaft 27. The circumferential position of housings 255 and 256 is adjusted in order to correspond angularly respectively with the open and closed position of the shutter 10. When the interlocking digit 251 is in the first position, the shutter 10 is therefore blocked in the open position or in the closed position.

In the second position, the interlocking digit 251 slides on the circumference of the locking disc 254 and controls the rotation of the support shaft 27 around axis XX′ in order to make it possible for the shutter 10 to go from the open position to the closed position, and the reverse.

The locking assembly 25 also comprises a counter spring 253 coaxial with a guide rod 252 supporting, at its extremity, the interlocking digit 251 itself. When the interlocking digit 251 is in the first position, the guide rod 252 is free to move translationally in the body of the electromagnet 250. The interlocking digit 251 is then held in its position in one of the housings (255, 256) by the action of the counter spring 253 interleaved between the body of the electromagnet 250 and the interlocking digit.

The interlocking digit 251 has a substantially rounded shape or one presenting a slope, complementary to the substantially concave or sloped shape of the first and second housing 255, 256. Also, when there is a torque greater than a predetermined threshold acting on the support shaft, the interlocking digit 251 can be disengaged from the housing (255, 256) in order to make it possible for the shutter 10 to pivot. The setting of the threshold can be done by adjusting the compression of the counter spring 253. This provision makes it possible, for example, to fold the shutter 10 when the latter is in open position and collides with an obstacle or experiences so great a force that it may be destroyed.

When the interlocking digit 251 is in the first position and the shutter 10 is blocked in rotation in open position or in closed position, the rotation around axis XX′ of the axial extension 201 of the spring is also blocked. The rotation of the engine sprocket 22 causes the rotation of the gear shaft 21, and the compression of the torsion spring 20.

The invention is also arranged such that the torque exercised by the torsion spring on the shaft 27 is less than a predetermined threshold of disengagement of the interlocking digit 251 from the housings 255 or 256. Likewise, the electromagnet 250 is capable of compressing the counter spring 253 in order to move the interlocking digit 251 from the first to the second position.

By making the gear shaft 21 turn in one direction, the spring 20 is compressed such that it creates opening torque on the shutter 10 and, when the gear shaft 21 is turned in the opposite direction, the spring 20 is compressed such that it creates closing torque on the shutter 10.

The ratio Φ₂/Φ₁ of the diameter Φ₂ of the gear shaft 21 and of the diameter Φ₁ of the engine sprocket 22 makes it possible to evaluate the multiplication between the engine torque of the principal actuator 23 measured at the motor shaft 220 and the tension sent to the torsion spring 20. This ratio makes it possible to measure the gain in electrical consumption realized by the principal actuator 23.

By way of example, for a spring capable of delivering a maximum torque on the order of 15 Nm, and for a ratio Φ₂/Φ₁ on the order of 4, the torque at the engine shaft 220 is usefully comprised between 1 to 8 Nm and the rotation speed of the engine sprocket 22 is comprised between 4 and 20 rotations per minute. The weaker the rotation speed of the engine shaft, the greater is the gain of torque, at equal power.

Moving the shutter 10 from the open position to the closed position, and the reverse, is done in one fourth of a rotation. As a general rule, for each of these positions, shutter 10 pushes against a stroke limiter in order to ensure its proper positioning.

Also, the motor assembly 2 of the aerodynamic blade 1 can also comprise a fluid shock absorber 24 acting on the support shaft 27 so as to reduce the impact of the shutter 10 against the stroke limiter during the movement of the shutter 10 from closed or opened.

Likewise, it may prove useful to equip the device with a position sensor 26 formed, for example, by a non-contact sensor, or even by a clutch 260 and a contact 261, as illustrated in detail in FIGS. 3a, 3b and 3c.

The tensioning of the spring is not instantaneous and may, therefore, last several seconds. This will be on the order of about ten seconds in the case of the powers and gear ratios cited above.

It is therefore appropriate to anticipate the compression of the torsion spring 20 such that, when the order for opening or closing is given by placing the interlocking digit 251 in second position, the shutter 10 can change position in a very short time, less than one second, and considered herein to be almost instantaneous.

Driving the aerodynamic blade 1 can then be usefully realized using a central unit 4 arranged in an appropriate place in the vehicle. The central unit 4 comprises, in its memory, coded instructions which, when executed, make it possible to implement the algorithms described below. The central unit is, therefore, connected, by means of suitable power electronics, to the principal actuator 23, to the electromagnet 250, to the contact 261, and to the vehicle control unit controlling the principal parameters of the vehicle.

The central unit 4 drives as a function of vehicle parameters, such as the speed of the vehicle, the temperature of the cooling water or even an imminent need such as a shock or the securitization of the vehicle, and in anticipation, the level of mechanical energy stored by the tensioning of the torsion spring 20, or the movement of the interlocking digit 251 authorizing the passage of the shutter 10 from one position to the other.

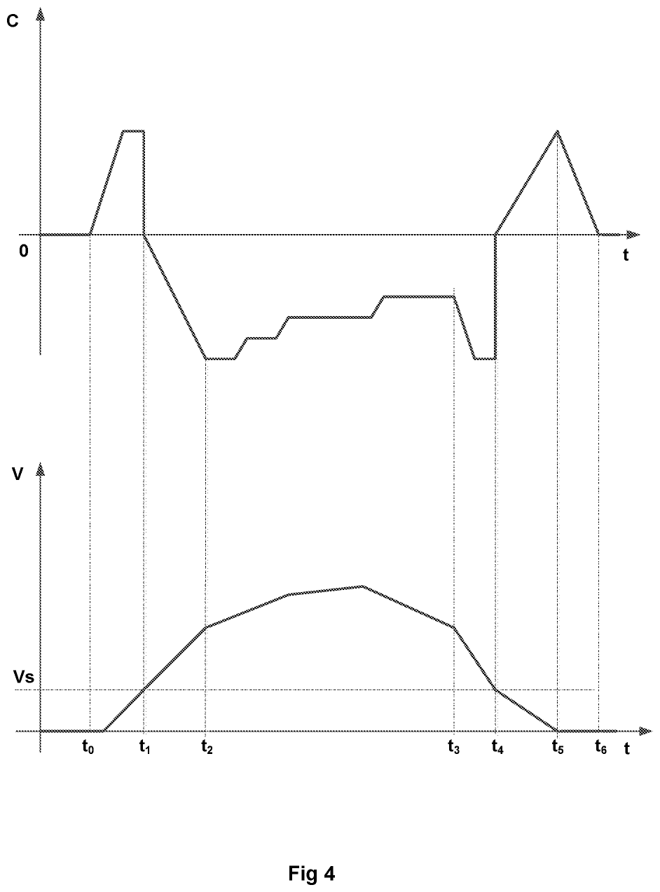

FIG. 4 illustrates, in the case of an aerodynamic blade disposed on the lower wall the evolution of the tension of the torsion spring 20 as a function of the speed of the vehicle during a rolling cycle.

At the time preceding time T0, the vehicle is off and the tension of the torsion spring is null. The shutter 10 is in the closed position and the interlocking digit 251 is in first position in the second housing 256.

At time T₀, the vehicle starts. At the moment of introduction of the contact key, the principal actuator is put into rotation so as to put the gear shaft in an angular stroke equivalent to the complete opening of the blade, and the tension in the torsion spring increases to the maximum predetermined level.

It is possible at this stage to slightly increase the angular value of the rotation of the gear shaft so as to conserve slight residual torque in the spring in order to ensure that the shutter 10 is completely open or completely closed. This residual torque is then taken up by the stroke limiter, then by the interlocking digit 251 when the latter goes from the second to the first position and is positioned in one of the housings 255 or 256.

At time t₁, the vehicle reaches and exceeds a given speed threshold Vs, for example the speed of 60 Km/h. The interlocking digit 251 then goes from the first to the second position and releases stored potential mechanical energy in the form of an opening torque in the torsion spring 20. The shutter 10 then pivots instantaneously by one fourth of a rotation of axis XX′, and goes to the open position. The interlocking digit 251 slides on the peripheral part of the locking disc 254 and, under the action of the counter spring 253, places itself in the first position in the first housing 255. The rotation of the support shaft 27 is blocked and the shutter 10 is maintained in open position.

The principal actuator 23 is then relaunched, in the reverse direction, in order to return the torsion spring 20 to compression so as to release a torque capable of causing the opening of the shutter 10 in anticipation of a closing order.

At time t₂, the spring tension is then maximum.

With the speed of the vehicle continuing to increase, the aerodynamic forces being applied to the shutter 10 also increase and may be added to the closing torque caused by the torsion spring 20, in the case where a closing order for the shutter 10 has been given. The principal actuator 23 then adjusts the tension of the torsion spring 20, decreasing it while speed remains high, as is the case between t₂ and t₃, or increasing it if necessary, as it the case at t₃, such that, in the case of a demand for change in the position of the shutter, the addition of the torque provided by the torsion spring and the torque created by the aerodynamic forces acting on the shutter 10 remains between two predetermined limits.

In order to avoid incessant movements of the principal actuator as a function of the speed of the vehicle, this adjustment can be usefully made by supports at 20 Km/h.

At time t₄, the speed of the vehicle again passes below the Vs threshold. The interlocking digit then passes to second position and the shutter 10 is quickly reclosed. The interlocking digit 251 returns to first position and places itself in the second housing 256.

The cycle, as described above, can then begin again.

When the vehicle is stopped at time t₅ and at the cut-off of contact, the principal actuator 23 continues to reduce the tension of the torsion spring 20 until it returns, at time t₆, to a null value.

In order to avoid consecutive opening and closing orders that are too close in time and to make the return of tension to the spring 20 possible, the central unit comprises an algorithm authorizing a single change of position of the shutter in a given time interval which can usefully be between 5 and 30 seconds.

It goes without saying, as cited above, that the simplified steering algorithm cited above can be integrated with other parameters such as, for example, the temperature of the cooling water.

The form of embodiment of the invention described in this specification, which seems to be the simplest and most economical way to resolve the problem posed and resolved using the means described in claim 1, can be done in various and equivalent forms of embodiment without, nonetheless, departing from the spirit of the invention itself.

### NOMENCLATURE

1 Aerodynamic blade.
10 Shutter.
11 Insertion.
2 Motor assembly.
20 Torsion spring.
201 First axial anchoring extension of the spring in the shutter.
202 Second axial anchoring extension of the spring in the gear shaft.
21 Gear shaft
210 Insertion.
22 Engine sprocket.
220 Motor shaft.
23 Principal actuator.
24 Fluid shock absorber
25 Locking assembly.
250 Electromagnet.
251 Interlocking digit.
252 Guide rod.
253 Counter spring
254 Locking disc.
255 First interlocking digit housing (open position).
256 Second interlocking digit housing (closed position).
26 Position sensor.
260 Clutch.
261 Contact.
27 Support shaft.
270 Support.
3 Releasing actuator.
4 Central unit
Φ₁ Diameter of engine sprocket 22.
Φ₂ Diameter of gear shaft 21.
XX′ Axis of the support shaft 27.

1. An aerodynamic blade for a motor vehicle, comprising:
a shutter mounted on a support shaft having an axis and connected to a chassis of a vehicle by at least one support, and driven in rotation around said axis between an open position and a closed position by a motor assembly,
wherein said motor assembly comprises one or more elements configured to accumulate mechanical energy and having an adjustable stored energy level to meet a demand for a sufficient torque to change a position of the shutter in a time of less than one second.

2. The aerodynamic blade according to claim 1, in which the one or more elements configured to accumulate mechanical energy comprise a torsion spring oriented along the axis of the support shaft.

3. The aerodynamic blade according to claim 1, in which the motor assembly comprises a locking assembly equipped with a mobile, interlocking digit configured to translate between a first and a second position, and configured such that, when the interlocking digit is in the first position, the rotation of the support shaft is blocked when the shutter is in the open or closed position, and when the interlocking digit is in the second position, the support shaft is in free rotation.

4. The aerodynamic blade according to claim 3, in which the locking assembly comprises a locking disc oriented along the axis of the support shaft, wherein the locking disc is mounted on the support shaft, and wherein the locking disc comprises a first housing and a second housing configured to receive the interlocking digit in the first position, when the shutter is, respectively, in the open position or in the closed position.

5. The aerodynamic blade according to claim 1, in which the motor assembly comprises a principal actuator fixed to the chassis of the vehicle driving an engine sprocket of a given diameter, coaxial to the axis of the support shaft, connected to a gear shaft mounted in free rotation on the support shaft.

6. The aerodynamic blade according to claim 5 in which the diameter of the gear shaft is greater than or equal to the diameter of the engine sprocket.

7. The aerodynamic blade according to claim 5, wherein the one or more elements configured to accumulate mechanical energy comprise a torsion spring oriented along the axis of the support shaft and in which a first axial extension of the torsion spring is mounted in an insertion arranged on an edge of the shutter and a second axial extension of the torsion spring is mounted in an insertion arranged on a face of the gear shaft, such that rotation of the engine sprocket causes the torsion spring to be tensioned when the interlocking digit is in the first position.

8. The aerodynamic blade according to claim 7, in which the motor assembly comprises a locking assembly equipped with a mobile, interlocking digit configured to translate between a first and a second position, and configured such that, when the interlocking digit is in the first position, the rotation of the support shaft is blocked when the shutter is in the open or closed position, and when the interlocking digit is in the second position, the support shaft is in free rotation and in which, when the interlocking digit is in the second position, the shutter is driven in rotation from one position to another position by the effect of the torque created by the torsion spring.

9. The aerodynamic blade according to claim 1, in which the motor assembly comprises a fluid shock absorber configured to brake the rotation of the support shaft.

10. The aerodynamic blade according to claim 1, in which the motor assembly comprises a position sensor configured to determine the open position or the closed position of the shutter.

11. The aerodynamic blade according to claim 8, associated with a central unit comprising algorithms in the form of coded instruction which, when executed, control:
rotation of the principal actuator in order to adjust the tension of the torsion spring, and
the position of the interlocking digit.

12. The aerodynamic blade according to claim 11, in which the central unit comprises an algorithm to drive the principal actuator so as to adjust the tension of the torsion spring as a function of one or more parameters of the vehicle.

13. The aerodynamic blade according to claim 11, in which the central unit comprises an algorithm to drive the locking assembly in order to control a passage of the shutter from one position to another position as a function of a threshold resulting from said vehicle parameters.

14. The aerodynamic blade according to claim 12, in which said vehicle parameters comprise at least one of the following: a vehicle speed, a cooling water temperature, and detection of an imminent need such as a shock or the securitization of the vehicle.

15. The aerodynamic blade according to claim 11, in which the central unit comprises an algorithm authorizing a single change of position of the shutter in a given time interval between 5 and 30 seconds.

16. The aerodynamic blade according to claim 12, in which the central unit comprises an algorithm to drive the principal actuator as a function of said vehicle parameters, so as to adjust, by means of successive supports, and when the interlocking digit is in the first position, the tension of the torsion spring such that, in the case of an order for the changing of the position of the shutter, the addition of the torque delivered by the torsion spring and by the torque created by the aerodynamic forces acting on the shutter remains between two predetermined limits.

17. The aerodynamic blade according to claim 11, in which the central unit comprises an algorithm to drive the principal actuator to bring the tension of the spring to a value close to zero when the vehicle motor is turned off.

18. An aerodynamic blade for a motor vehicle, comprising:
a shutter mounted on a support shaft having an axis and connected to a chassis of a vehicle by at least one support and driven in rotation around said axis between an open position and a closed position by a motor assembly,
wherein said motor assembly comprises a torsion spring oriented along the axis of the support shaft and configured to accumulate mechanical energy, and
wherein a level of energy stored by the torsion spring can be adjusted to meet a demand for a sufficient torque to change a position of the shutter in a time of less than one second.

19. The aerodynamic blade of claim 18, in which the motor assembly comprises a locking assembly equipped with a mobile, interlocking digit configured to translate between a first and a second position, and configured such that, when the interlocking digit is in the first position, the rotation of the support shaft is blocked when the shutter is in the open position or the closed position, and when the interlocking digit is in the second position, the support shaft is in free rotation.

20. The aerodynamic blade according to claim 19, in which the locking assembly comprises a locking disc oriented along the axis of the support shaft, wherein the locking disc is mounted on the support shaft, and wherein the locking disc comprises a first housing configured to receive the interlocking digit in the first position when the shutter is in the open position and a second housing configured to receive the interlocking digit in the first position when the shutter is in the closed position.
